(19) United States
(12) Patent Application Publication
(10) Pub. No.: US 2015/0117722 A1
(43) Pub. Date: Apr. 30, 2015

(54) INSPECTION APPARATUS

(71) Applicant: FUJI XEROX CO., LTD., Tokyo (JP)

(72) Inventors: Hideki MORIYA, Kanagawa (JP); Kiyofumi AIKAWA, Kanagawa (JP)

(73) Assignee: FUJI XEROX CO., LTD., Tokyo (JP)

(21) Appl. No.: 14/294,750

(22) Filed: Jun. 3, 2014

(30) Foreign Application Priority Data
Oct. 30, 2013 (JP) 2013-225218

(51) Int. Cl. G06K 9/00; G06K 9/20

(52) U.S. Cl. CPC G06K 9/00442; G06K 9/2027; G06K 9/2018
USPC 382/112

(57) ABSTRACT

Provided is an inspection apparatus including a first light receiving unit that receives light from an object where an image is formed based on image data with a first spectral sensitivity characteristic, a second light receiving unit that has a resolution lower than a resolution of the first light receiving unit and receives the light from the object with a second spectral sensitivity characteristic different from the first spectral sensitivity characteristic of the first light receiving unit, and an inspection unit that executes a first inspection for inspecting whether a text or a figure corresponding to the image data is present at a position on the first image and executes a second inspection for inspecting whether halftone dots are formed at a position on the second image.

### CROSS-REFERENCE TO RELATED APPLICATIONS

This application is based on and claims priority under 35 USC 119 from Japanese Patent Application No. 2013-225218 filed Oct. 30, 2013.

### BACKGROUND

### Technical Field

The present invention relates to an inspection apparatus.

### SUMMARY

According to an aspect of the invention, there is provided an inspection apparatus including:

a first light receiving unit that receives light from an object where an image is formed based on image data with a first spectral sensitivity characteristic;

a second light receiving unit that has a resolution lower than a resolution of the first light receiving unit and receives the light from the object with a second spectral sensitivity characteristic different from the first spectral sensitivity characteristic of the first light receiving unit; and

an inspection unit that executes a first inspection for inspecting, based on a first image received by the first light receiving unit, whether a text or a figure corresponding to the image data is present at a position on the first image corresponding to a position on the image data where the text or the figure formed by a line is to be present and executes a second inspection for inspecting, based on a second image received by the second light receiving unit, whether halftone dots are formed at a position on the second image corresponding to a position on the image data where color is expressed in a halftone.

### BRIEF DESCRIPTION OF THE DRAWINGS

Exemplary embodiments of the present invention will be described in detail based on the following figures, wherein:

FIG. 1 is a block diagram illustrating an overall configuration of an inspection system;

FIG. 2 is a diagram schematically illustrating a configuration of an image reading unit;

FIGS. 3A and 3B are diagrams illustrating a performance difference of an image sensor; and

FIG. 4 is a diagram illustrating a procedure of inspections executed by the inspection system.

### DETAILED DESCRIPTION

### Example

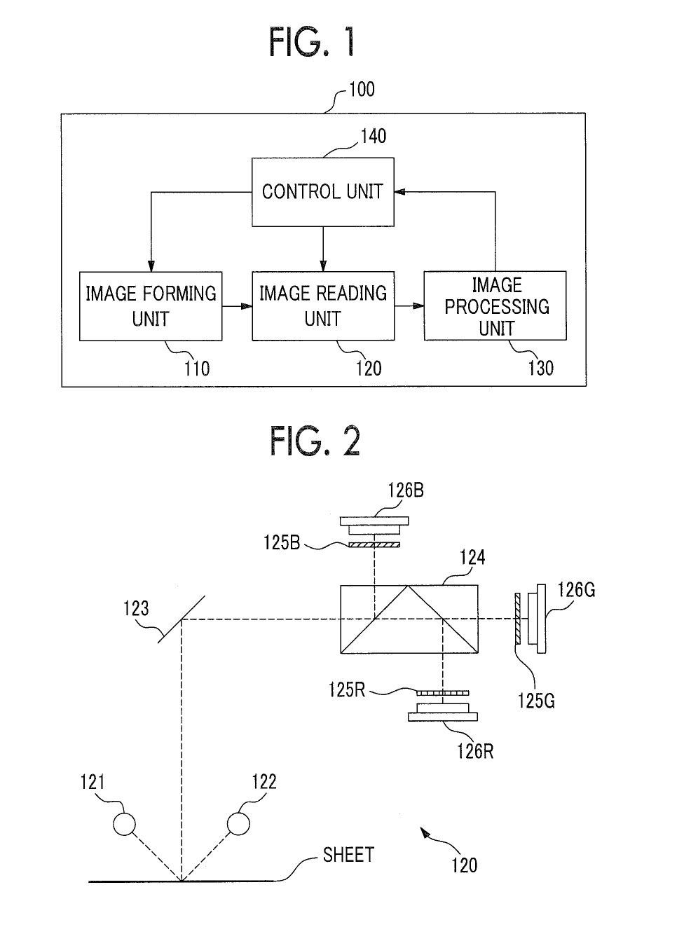

FIG. 1 is a block diagram illustrating an overall configuration of an inspection system 100 according to an example of the invention. The inspection system 100 is a system that forms an image on a sheet and inspects the image formed on the sheet. That is, in the present example, an object to be inspected corresponds to a sheet on which an image is formed. The inspection system 100 includes an image forming unit 110, an image reading unit 120, an image processing unit 130, and a control unit 140.

The image forming unit 110 is a unit that forms an image. The image forming unit 110 forms an image on a sheet based on image data received through a communication unit or stored on a storage medium. The image forming unit 110 forms a color image on a sheet using toners of cyan, magenta, yellow and black by an electrophotographic method. Here, a recording method of the image forming unit 110 may employ a type (ink jet type, thermal transfer type or the like) other than the electrophotographic method, and colors or the number of colors to be used are not particularly limited.

The image reading unit 120 is a unit that reads an image. The image reading unit 120 optically reads an image formed on a sheet, and generates image data indicating the read image. In the present example, the image reading unit 120 has a configuration for reading a color image. That is, in the present example, the image reading unit 120 is configured to separate light reflected from the sheet into three components of red (R), green (G) and blue (B) and to generate image data of respective components of an RGB color system. Here, the image reading unit 120 may be configured to separate the reflected light into tristimulus values (X, Y and Z) and to generate image data of respective components of an XYZ color system.

Hereinafter, the image data used by the image forming unit 110 in image formation is referred to as “original image data”, and the image data generated by the image reading unit 120 is referred to as “read data”, to distinguish between two types of image data.

The image processing unit 130 is a unit that executes image processing. The image processing unit 130 executes image processing necessary for image inspection for the read data. The image processing executed by the image processing unit 130 includes a filtering process for shading off an image indicated by the read data. The filtering process corresponds to a so-called averaging process (smoothing process) or the like, and specifically, is realized by a low path filter, a moving average filter, a weighted average filter or the like. The image processing unit 130 may execute a known image processing (shading correction or the like) other than the filtering process, as necessary.

The control unit 140 is a unit that controls an operation of each unit of the inspection system 100. For example, the control unit 140 controls the image formation in the image forming unit 110, and allows the image reading unit 120 to read an image according to the image formation in the image forming unit 110. Further, the control unit 140 may control the image formation in the image forming unit 110 based on the inspection result. Here, the control includes a timing control of the start and end of the image formation and an image quality control (that is, feedback of the inspection result).

Further, the control unit 140 is a unit that executes the inspection based on the image indicated by the read data. That is, the control unit 140 realizes a function corresponding to an example of an inspection unit according to an exemplary embodiment of the invention. The control unit 140 executes plural inspections using the read data of plural color components. Specifically, the control unit 140 executes a line inspection, a halftone inspection and a color inspection.

The control unit 140 includes an arithmetic processor such as a central processing unit (CPU) and a memory, and is operated by executing a program. Further, the image processing unit 130 may be configured in a hardware form by an exclusive image processing circuit, or may be realized in a software form as a function of the control unit 140.

FIG. 2 is a diagram schematically illustrating a configuration of the image reading unit 120. The image reading unit 120 includes light sources 121 and 122, an optical system member 123, a splitter 124, color filters 125R, 125G and 125B, and image sensors 126R, 126G and 126B.

The light sources 121 and 122 are units that illuminate a sheet that is an object. The light sources 121 and 122 are configured by a xenon lamp or a light emitting diode (LED), for example, and respectively emit light to a sheet transported along a transport path from a front side or a rear side of the sheet. Further, the light sources 121 and 122 are configured to have a width according to the sheet in a main scanning direction (in a direction perpendicular to the page face). Only one of the light sources 121 and 122 may be sufficient for the above operation, and in this case, the other one thereof may not be provided.

The optical system member 123 is a unit that guides light to a predetermined path. The optical system member 123 introduces light emitted from the light sources 121 and 122 and reflected in the sheet (that is, reflected light from the sheet) to the splitter 124. The optical system member 123 is simply shown as a single mirror in FIG. 2, but may be configured by plural mirrors to perform reflection plural times, or may be configured using a different member such as a lens.

The splitter 124 is a unit that divides incident light. The splitter 124 divides the reflected light from the sheet in three directions. The reflected light from the sheet after being emitted from the splitter 124 is incident to the image sensors 126R, 126G and 126B, respectively. The splitter 124 corresponds to an example of a spectral unit according to the exemplary embodiment of the invention.

The color filters 125R, 125G and 125B are units that allow passage of a component of a specific wavelength band among the reflected light from the sheet and suppress passage of components of different wavelength bands, respectively. For example, the color filter 125R is a filter having a spectral sensitivity characteristic that allows passage of a component of a red wavelength band and suppresses passage of components of different wavelength bands. Similarly, the color filter 1256 allows passage of a component of a green wavelength band, and the color filter 125B allows passage of a component of a blue wavelength band. Each of the color filters 125R, 125G and 125B may have any configuration as long as it may selectively allow passage of a component of a desired wavelength band. When allowing passage of a component of a specific wavelength band in the XYZ color system, for example, a color filter obtained by linearly converting a color function such as an RGB may be used.

The image sensors 126R, 126G and 126B are units that receive light passed through the color filters 125R, 125G and 125B to generate an electric signal based on the light intensity. Each of the image sensors 126R, 126G and 126B corresponds to an example of a light receiving unit according to the exemplary embodiment of the invention. The image sensors 126R, 126G and 126B are line sensors configured by a charge coupled device (CCD) image sensor or a complementary metal-oxide semiconductor (CMOS) image sensor, for example.

The image sensors 126R, 126G and 126B receive the reflected light from the sheet with the spectral sensitivity characteristic based on the color filters 125R, 125G and 125B that are provided in the front stage, respectively. For example, the image sensor 126R selectively receives a component of a red wavelength band. Similarly, the image sensor 126G selectively receives a component of a green wavelength band, and the image sensor 126B selectively receives a component of a blue wavelength band.

Further, in the present example, the image sensors 126R, 126G and 126B are configured so that resolutions (spatial resolutions) are different from each other. Specifically, in the present example, the resolution of the image sensor 126G is configured to be higher than the resolutions of the image sensors 126R and 126B. In other words, the image sensor 126G is configured to be able to read an image with high accuracy compared with the image sensors 126R and 126B.

As a method of providing the different resolutions, when the image sensors 126R, 126G and 126B are the same type sensor, a method is considered in which the image sensor 126G is provided at a position where the image sensor 126G is in a focusing state and the image sensors 126R and 126B are provided at a position spaced by a predetermined distance from a position where the image sensors 126R and 126B are in a focusing state. Alternatively, a filter (low path filter or the like) having a low resolution may be provided for the image sensors 126R and 126B. Further, as the image sensor 126G, a sensor having a high resolution compared with the image sensors 126R and 126B may be used.

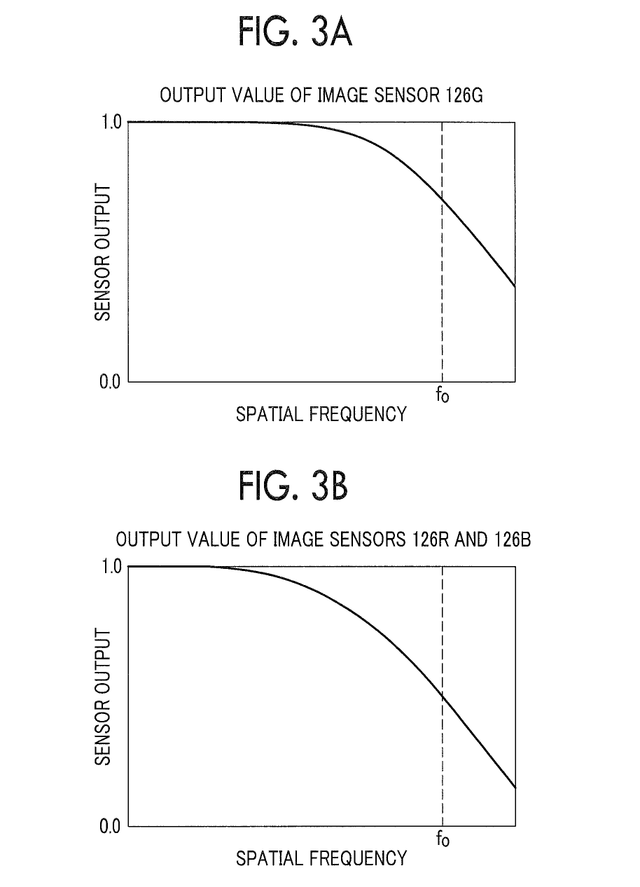

FIGS. 3A and 3B are diagrams illustrating a performance difference between the image sensor 126G and the image sensors 126R and 126B. In graphs shown in FIGS. 3A and 3B, the longitudinal axis represents a sensor output (minimum 0.0 and maximum 1.0) when a rectangular wave is read, and the transverse axis represents a spatial frequency of the rectangular wave. Here, the rectangular wave corresponds to a fine line on a sheet, and the spatial frequency corresponds to the thickness of the fine line. Further, a frequency f₀ in the figure represents a minimum frequency of a halftone dot structure included in an image formed on a sheet.

As shown in FIGS. 3A and 3B, a sensor output value at the frequency f₀ is large in the image sensor 126G, compared with the image sensors 126R and 126B. Specifically, the output value in the image sensors 126R and 126B is approximately half the maximum value. That is, when the fine line or halftone dots corresponding to the frequency f₀ are read, the reading is performed in a blurred state in the image sensors 126R and 126B, compared with the image sensor 126G.

The inspection system 100 has the configuration as described above. With this configuration, the inspection system 100 inspects, after an image based on the original image data is formed on a sheet, the quality of the image formed on the sheet. As described above, the inspection executed in the inspection system 100 includes three types of the line inspection, the halftone inspection and the color inspection. Here, only two types of the line inspection and the color (gradation) inspection may be performed according to an image to be inspected (for example, a sheet on which a monochromatic image such as a white-and-black image is formed).

Here, the line inspection refers to an inspection on whether a correct text or figure based on original image data is present at a position on a sheet where a text or a figure formed by a line corresponding to the original image data is to be present. In the case of a text inspection, an inspection on whether a correct text is present at a position whether the text is to be present is performed. Here, the text refers to characters, numerals, symbols or the like. The text inspection is performed to inspect a wrong word or an omitted word. Further, the inspection system 100 may inspect a font.

The inspection system 100 may inspect a fine line in a similar way to the text inspection. Here, the fine line refers to a ruled line of a graph, or the like. Further, the inspection system 100 may inspect a figure or illustration drawn by the fine line.

Further, the halftone inspection refers to an inspection on whether halftone dots are formed at a position on a sheet where a color is to be reproduced in a halftone (that is, in a middle tone) corresponding to original image data. In other words, the halftone inspection refers to an inspection on whether the halftone dots are formed. Here, the inspection of the presence or absence of the halftone dots is enough, and thus, it is not necessary to inspect the tone of color reproduced by the halftone dots.

Further, the color inspection refers to an inspection of a color of a character or an image formed on a sheet. Here, the color inspection corresponds to color measurement using a color measurement device (colorimeter). The inspection system 100 calculates a gradation value of each color based on the output values of the image sensors 126R, 126G and 126B to measure the color at each position of the sheet. When a color filter based on the XYZ color system is used, the tristimulus values are calculated based on the output values of the respective sensors to measure the color at each position of the sheet (stimulus value direct reading method).

The inspection system 100 performs these inspections by comparing the read data with the original image data. The inspection system 100 divides the entire image indicated by the original image data into plural regions, and executes the inspection for each region. Here, the region includes a “text region” where the text is formed and a “halftone region” where the halftone dots are formed, for example. In this case, the inspection system 100 executes the text inspection for the text region, and executes the halftone inspection for the halftone region. Further, the inspection system 100 may execute the color inspection for the entire image indicated by the original image data, or may execute the color inspection for a predetermined part of the regions.

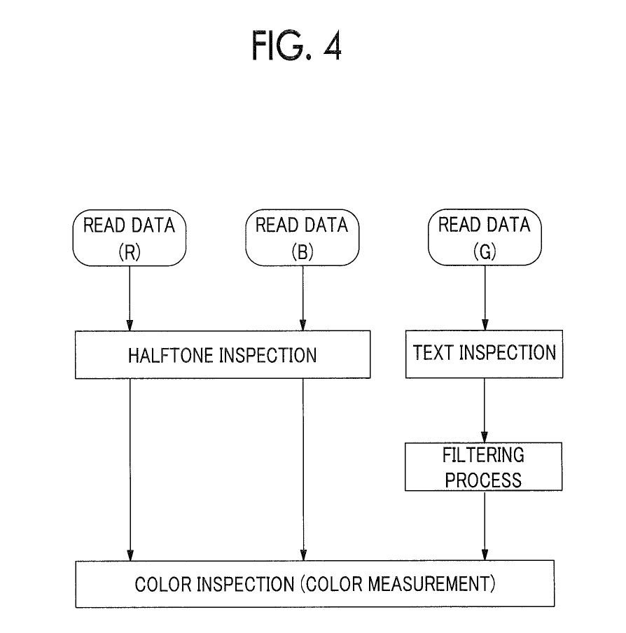

FIG. 4 is a diagram illustrating a procedure of the inspections executed by the inspection system 100. The inspection system 100 generates read data of red, blue and green, and executes the inspections using the read data. As shown in FIG. 4, the inspection system 100 executes the halftone inspection using the read data of red and blue (or any one of red and blue). That is, the inspection system 100 inspects whether the halftone dots are formed at a position on the read data of red and blue (or any one of red and blue) corresponding to a position on original image data where color is expressed in a halftone. Further, the inspection system 100 executes the line inspection using the read data of green. That is, the inspection system 100 inspects whether the text or the figure corresponding to the original image data is present at a position on the read data of green corresponding to a position on the original image data where the text or the figure formed by the line is present. The reason why the read data of green (that is, image data read with high resolution) is used for the text inspection is because a sharp image is necessary for the text inspection. On the other hand, a sharp image is not necessary for the halftone inspection, and rather, it is preferable that the contrast between a portion where the halftone dots are formed and a portion where the halftone dots are not formed (a portion corresponding to the background) be low to a certain degree.

Then, the inspection system 100 executes the color inspection using the read data of three colors. The inspection system 100 executes image processing for the read data of green, prior to the color inspection. That is, the read data of green is used for the text inspection before the image processing is executed, and is used for the color inspection after the image processing is executed. The image processing executed for the read data of green is a filtering process for shading off an image indicated by the read data of green. By executing such image processing, the sharpness of the image indicated by the read data of green is reduced, and is close to the sharpness of images indicated by the read data of the other colors, compared with a case before the image processing is executed.

As described above, the inspection system 100 executes the inspection according to the sharpness of each read data (that is, the resolution of the sensor that generates each read data) using the read data of the plural colors. Further, the inspection system 100 executes the color inspection using the combination of the plural pieces of read data after executing the inspection according to each read data. Further, in this case, the inspection system 100 executes the image processing so that the sharpness difference between the pieces of read data of the respective colors is small.

### Modification Examples

The above-described example is only an exemplary embodiment of the invention. The invention is not limited to this exemplary embodiment, and may be realized as the following modification examples. Further, the modification examples shown herein may be appropriately combined with each other as necessary.

(1) In the invention, the number of the light receiving units may have only to be plural, and is not limited to three. Accordingly, the number of the light receiving units may be four or more. Further, the number of the light receiving units may be two according to the object or the inspection content. Further, the light receiving unit having relatively high resolution is not necessary to be the light receiving unit corresponding to green as in the above-described example, and may be the light receiving unit corresponding to any color. When the light receiving unit having relatively high resolution is selected, if the light receiving unit capable of receiving light in a wide wavelength region is configured to have relatively high resolution to be used in the text inspection, it is possible to suppress deterioration of the text recognition accuracy depending on the color of the text.

(2) In the invention, the light receiving unit may have a configuration in which the splitter is not used, and for example, may have a configuration in which line sensors of plural colors are arranged in parallel and read data of each color is generated in each line sensor. Further, the color filter may be provided inside the splitter (a surface that reflects or transmits light), instead of being provided between the splitter and the image sensor.

(3) The above-described inspection system 100 is configured by a combination of an inspection apparatus and an image forming apparatus. For example, the image forming unit 110 corresponds to the image forming apparatus, and the image reading unit 120, the image processing unit 130 and the control unit 140 correspond to the inspection apparatus. Here, the invention is not limited to this configuration, and for example, may be realized as a single inspection apparatus.

Further, the object to be inspected in the exemplary embodiment of the invention is not limited to a sheet on which an image is formed in the image forming apparatus (in a field of the image forming apparatus). For example, the inspection apparatus according to the exemplary embodiment of the invention may inspect a printed matter separately created by a printer. Further, the object to be inspected is not limited to the sheet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An inspection apparatus comprising:
a first light receiving unit that receives light from an object where an image is formed based on image data with a first spectral sensitivity characteristic;
a second light receiving unit that has a resolution lower than a resolution of the first light receiving unit and receives the light from the object with a second spectral sensitivity characteristic different from the first spectral sensitivity characteristic of the first light receiving unit; and
an inspection unit that executes a first inspection for inspecting, based on a first image received by the first light receiving unit, whether a text or a figure corresponding to the image data is present at a position on the first image corresponding to a position on the image data where the text or the figure formed by a line is to be present and executes a second inspection for inspecting, based on a second image received by the second light receiving unit, whether halftone dots are formed at a position on the second image corresponding to a position on the image data where color is expressed in a halftone.

2. The inspection apparatus according to claim 1,
wherein the inspection unit executes a third inspection for measuring and inspecting color of the image formed in the object based on the first image and the second image.

3. The inspection apparatus according to claim 2, further comprising:
an image processing unit that executes image processing for shading off the first image, for the first image,
wherein the inspection unit executes the first inspection based on the first image for which the image processing is not executed and executes the third inspection based on the first image for which the image processing has been executed.

4. The inspection apparatus according to claim 1, further comprising:
a spectral unit that divides the light from the object into at least light of a first wavelength region and light of a second wavelength region that is different from the light of the first wavelength region,
wherein the first light receiving unit receives the light of the first wavelength region, and the second light receiving unit receives the light of the second wavelength region.

5. The inspection apparatus according to claim 2, further comprising:
a spectral unit that divides the light from the object into at least light of a first wavelength region and light of a second wavelength region that is different from the light of the first wavelength region,
wherein the first light receiving unit receives the light of the first wavelength region, and the second light receiving unit receives the light of the second wavelength region.

6. The inspection apparatus according to claim 3, further comprising:
a spectral unit that divides the light from the object into at least light of a first wavelength region and light of a second wavelength region that is different from the light of the first wavelength region,
wherein the first light receiving unit receives the light of the first wavelength region, and the second light receiving unit receives the light of the second wavelength region.

7. The inspection apparatus according to claim 1,
wherein the first light receiving unit has a wavelength region for reception wider than a wavelength region for reception of the second light receiving unit.

8. The inspection apparatus according to claim 2,
wherein the first light receiving unit has a wavelength region for reception wider than a wavelength region for reception of the second light receiving unit.

9. The inspection apparatus according to claim 3,
wherein the first light receiving unit has a wavelength region for reception wider than a wavelength region for reception of the second light receiving unit.

10. The inspection apparatus according to claim 4,
wherein the first light receiving unit has a wavelength region for reception wider than a wavelength region for reception of the second light receiving unit.

11. The inspection apparatus according to claim 5,
wherein the first light receiving unit has a wavelength region for reception wider than a wavelength region for reception of the second light receiving unit.

12. The inspection apparatus according to claim 6,
wherein the first light receiving unit has a wavelength region for reception wider than a wavelength region for reception of the second light receiving unit.

13. An inspection apparatus comprising:
a first light receiving unit that receives light from an object where an image is formed based on image data with a first spectral sensitivity characteristic;
a second light receiving unit that has a resolution lower than a resolution of the first light receiving unit and receives the light from the object with a second spectral sensitivity characteristic different from the first spectral sensitivity characteristic of the first light receiving unit; and
an inspection unit that executes a first inspection for inspecting, based on a first image received by the first light receiving unit, whether a text or a figure corresponding to the image data is present at a position on the first image corresponding to a position on the image data where the text or the figure formed by a line is to be present and executes a second inspection for measuring and inspecting color of the image formed in the object based on the first image and the second image.

14. The inspection apparatus according to claim 13, further comprising:
an image processing unit that executes image processing for shading off the first image, for the first image,
wherein the inspection unit executes the first inspection based on the first image for which the image processing is not executed and executes the second inspection based on the first image for which the image processing has been executed.

15. The inspection apparatus according to claim 13, further comprising:
a spectral unit that divides the light from the object into at least light of a first wavelength region and light of a second wavelength region that is different from the light of the first wavelength region,
wherein the first light receiving unit receives the light of the first wavelength region, and the second light receiving unit receives the light of the second wavelength region.

16. The inspection apparatus according to claim 14, further comprising:
a spectral unit that divides the light from the object into at least light of a first wavelength region and light of a second wavelength region that is different from the light of the first wavelength region,
wherein the first light receiving unit receives the light of the first wavelength region, and the second light receiving unit receives the light of the second wavelength region.

17. The inspection apparatus according to claim 13,
wherein the first light receiving unit has a wavelength region for reception wider than a wavelength region for reception of the second light receiving unit.

18. The inspection apparatus according to claim 14,
wherein the first light receiving unit has a wavelength region for reception wider than a wavelength region for reception of the second light receiving unit.

19. The inspection apparatus according to claim 15,
wherein the first light receiving unit has a wavelength region for reception wider than a wavelength region for reception of the second light receiving unit.

20. The inspection apparatus according to claim 16,
wherein the first light receiving unit has a wavelength region for reception wider than a wavelength region for reception of the second light receiving unit.
